(19) United States
(12) Patent Application Publication
(10) Pub. No.: US 2011/0085338 A1
(43) Pub. Date: Apr. 14, 2011

(54) Lamp with magnifier

(76) Inventor: James LU, Guangdong Province (CN)

(21) Appl. No.: 12/577,220

(22) Filed: Oct. 12, 2009

(51) Int. Cl. F21S 8/00

(52) U.S. Cl. 362/268; 362/281

(57) ABSTRACT

The present invention provides a lamp with magnifier which has a lighting lamp, a lampshade, a magnifying lens, a lamp arm and a lamp body fixing means; the lighting lamp is fixedly disposed under the lampshade; the magnifying lens is disposed in a central position of the lampshade; the lampshade is movably connected with an upper end of the lamp arm via a first rotating shaft and rotatable in a vertical plane; the lampshade is freely rotatable around the first rotating shaft in a horizontal plane; the lamp arm comprises an upper lamp arm and a lower lamp arm which are movably connected with each other forming an adjustable angle in between; the lower lamp arm is movably connected with the lamp body fixing means, and the lower lamp arm is rotatable in a horizontal plane relative to the lamp body fixing means.

### BACKGROUND OF THE INVENTION

The present invention relates to a lamp with magnifier for magnified observation.

A lamp with magnifier generally comprises a magnifying lens, a lighting lamp, a power supply for the lighting lamp and a base. The light source generally comprises cold cathode fluorescent lamps or a plurality of light emitting diodes, and it is disposed at the outer periphery of the magnifying lens. The power source converts alternating current of 110V/220V to direct current of a safe voltage for the light source, so that dangerous voltage is separated from the magnifying lamp. The base is made of insulating plastic material in general. It is provided with a handle for installing the lighting lamp, the magnifying lens, the adjusting and controlling circuit for the power supply and the switch and for hand-held purposes. As the present invention consumes little electricity and has low voltage, it is safe for human. In combination with the magnifying lens, the present invention is convenient for use by the visually impaired and the elderly with poor eyesight. It is also convenient for observing minute objects, texts, images and so forth. Therefore, it is widely applicable for precise machinery repair, sculpture or embroidery works and for use by learners.

However, the lighting lamp and the base of existing magnifying lamp are fixedly connected with each other. Even with improvements in the movable connection between the lamp arm and the base, the disadvantages of small working area and poor flexibility of the lamp body still persist. Besides, for magnifying lamps with a wider range of magnification, it is difficult for existing magnifying lamps to fulfill the application needs.

### BRIEF SUMMARY OF THE INVENTION

In view of the aforesaid disadvantages now present in the prior art, the present invention provides a lamp with magnifier which has a larger working area and is more flexible to use.

To attain this, the present invention adopts the technical proposal as follows: A lamp with magnifier which comprises a lighting lamp, a lampshade, a magnifying lens, a lamp arm and a lamp body fixing means; the lighting lamp is fixedly disposed under the lampshade; the magnifying lens is disposed in a central position of the lampshade; the lampshade is movably connected with an upper end of the lamp arm and rotatable in a vertical plane; characterized in that the lampshade is connected to the upper end of the lamp arm via a first rotating shaft; the lampshade is freely rotatable in a horizontal plane around the first rotating shaft; the lamp arm comprises an upper lamp arm and a lower lamp arm; the upper lamp arm and the lower lamp arm are movably connected with each other forming an adjustable angle in between; the lower lamp arm is movably connected with the lamp body fixing means, and the lower lamp arm is rotatable in a horizontal plane relative to the lamp body fixing means.

A second magnifying lens is disposed above the lampshade; the second magnifying lens comprises a second magnifying lens piece and a magnifying lens support; the second magnifying lens is connected to a second rotating shaft and is rotatable in a horizontal plane relative to the lampshade.

The first rotating shaft is disposed with a limiting means, and the lampshade is freely rotatable in a horizontal plane around the first rotating shaft for 350 degrees.

The magnifying lens is removably connected with the lampshade.

The second magnifying lens piece is removably connected with the magnifying lens support.

The upper lamp arm and the lower lamp arm are each disposed with positioning springs.

The lamp body fixing means is in form of an F-shaped clamp, and the F-shaped clamp is fixedly mounted onto a fixed object via screws.

The present invention is advantageous in that it has a wider magnification range and a larger working area, and being more flexible to use and widely applicable.

### BRIEF DESCRIPTION OF THE DRAWINGS

FIG. 1 shows a perspective view of the present invention.

In the drawings, 1 indicates the lampshade; 2 indicates the magnifying lens; 3 indicates the lamp body fixing means; 4 indicates the first rotating shaft; 5 indicates the upper lamp arm; 6 indicates the lower lamp arm; 7 indicates the second magnifying lens piece; 8 indicates the magnifying lens support; 9 indicates the second rotating shaft; 10 indicates the bayonet slots; 11 indicates the positioning spring; 12 indicates the F-shaped clamp; 13 indicates the screw.

### DETAILED DESCRIPTION OF THE INVENTION

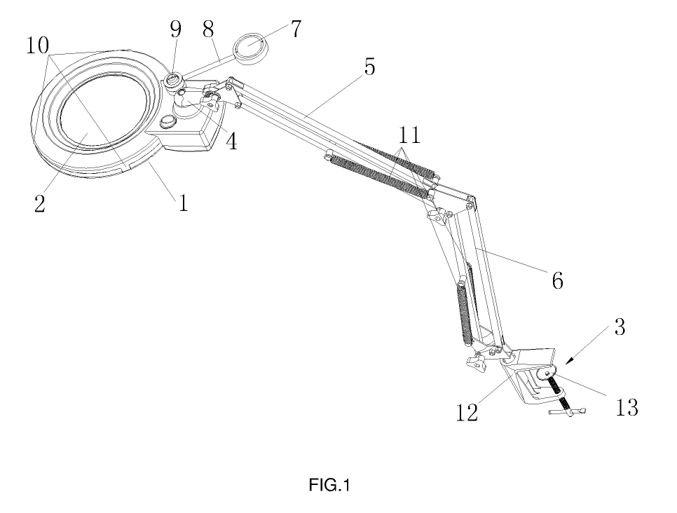

As illustrated in FIG. 1, the lamp with magnifier comprises a lighting lamp, a lampshade 1, a magnifying lens 2, a lamp arm and a lamp body fixing means 3. The lighting lamp is fixedly disposed under the lampshade 1. The magnifying lens 2 is disposed in a central position of the lampshade 1. The lampshade 1 is movably connected with an upper end of the lamp arm and rotatable in a vertical plane. The lampshade 1 is connected to the upper end of the lamp arm via a first rotating shaft 4. The lampshade 1 is freely rotatable in a horizontal plane around the first rotating shaft 4. The lamp arm comprises an upper lamp arm 5 and a lower lamp arm 6. The upper lamp arm 5 and the lower lamp arm 6 are movably connected with each other forming an adjustable angle in between. The lower lamp arm 6 is movably connected to the lamp body fixing means 3. The lower lamp arm 6 is rotatable in a horizontal plane relative to the lamp body fixing means 3.

A second magnifying lens is disposed above the lampshade. The second magnifying lens comprises a second magnifying lens piece 7 and a magnifying lens support 8. The second magnifying lens is connected to a second rotating shaft 9 and is rotatable in a horizontal plane relative to the lampshade 1.

The first rotating shaft 4 is disposed with a limiting means, and the lampshade 1 is freely rotatable in a horizontal plane around the first rotating shaft 4 for 350 degrees.

There are three bayonet slots 10 disposed in the outer periphery of the lampshade 1. The magnifying lens 2 may be removed by rotating the bayonet slots 10. Replacement of magnifying lens 2 of different magnification is achieved by removing the magnifying lens 2.

The second magnifying lens piece 7 is removably connected with the magnifying lens support 8. By removing the second magnifying lens piece 7, magnification may be further adjusted, thereby attaining wider applicability.

The upper lamp arm 5 and the lower lamp arm 6 are each disposed with two positioning springs 11. The positioning springs 11 enhances the positioning capability of the lamp arm, thereby preventing displacement when in use.

The lamp body fixing means 3 is in form of an F-shaped clamp 12, and the F-shaped clamp 12 is fixedly mounted onto the platform of a fixed board-shaped object via screws 13.

When in use, it should be ensured that the surface of the magnifying lens of the present invention is clean and tidy. To prevent blurred visual effect during magnification and damage of the positioning means, the lampshade may not be rotated for 360 degrees.

Finally, it should be stated that the above embodiment is for the purpose of description and should not be regarded as limiting. Therefore, even though the present specification has described the present invention in detail with reference to the above embodiment, a person skilled in the art should appreciate that the present invention is capable of other variation or substitution. Any other technical proposal and improvements not deviated from the spirit of the present invention falls within the scope of the claims of the present invention.

What is claimed is:

1. A lamp with magnifier which comprises a lighting lamp, a lampshade, a magnifying lens, a lamp arm and a lamp body fixing means; the lighting lamp is fixedly disposed under the lampshade; the magnifying lens is disposed in a central position of the lampshade; the lampshade is movably connected with an upper end of the lamp arm and rotatable in a vertical plane; characterized in that the lampshade is connected to the upper end of the lamp arm via a first rotating shaft; the lampshade is freely rotatable in a horizontal plane around the first rotating shaft; the lamp arm comprises an upper lamp arm and a lower lamp arm; the upper lamp arm and the lower lamp arm are movably connected with each other forming an adjustable angle in between; the lower lamp arm is movably connected with the lamp body fixing means, and the lower lamp arm is rotatable in a horizontal plane relative to the lamp body fixing means.

2. A lamp with magnifier as in claim 1, wherein a second magnifying lens is disposed above the lampshade; the second magnifying lens comprises a second magnifying lens piece and a magnifying lens support; the second magnifying lens is connected to a second rotating shaft and is rotatable in a horizontal plane relative to the lampshade.

3. A lamp with magnifier as in claim 1 or 2, wherein the lampshade is freely rotatable in a horizontal plane around the first rotating shaft for 350 degrees.

4. A lamp with magnifier as in claim 1 or 2, wherein the magnifying lens is removably connected with the lampshade.

5. A lamp with magnifier as in claim 2, wherein the second magnifying lens piece is removably connected with the magnifying lens support.

6. A lamp with magnifier as in claim 1 or 2, wherein the upper lamp arm and the lower lamp arm are each disposed with positioning springs.

7. A lamp with magnifier as in claim 1 or 2, wherein the lamp body fixing means is in form of an F-shaped clamp, and the F-shaped clamp is fixedly mounted onto a fixed object via screws.
